(19) United States
(12) Patent Application Publication
(10) Pub. No.: US 2026/0235762 A1
(43) Pub. Date: Aug. 13, 2026

(54) INFORMATION PROCESSING APPARATUS, RANGING SYSTEM, INFORMATION PROCESSING METHOD, AND PROGRAM

(71) Applicant: KABUSHIKI KAISHA TOSHIBA, Kawasaki-shi Kanagawa (JP)

(72) Inventors: Yutaka OTA, Yokohama Kanagawa (JP); Satoshi KONDO, Shinjuku Tokyo (JP); Tuan Thanh TA, Kawasaki Kanagawa (JP)

(73) Assignee: KABUSHIKI KAISHA TOSHIBA, Kawasaki-shi Kanagawa (JP)

(21) Appl. No.: 19/538,156

(22) Filed: Feb. 12, 2026

(30) Foreign Application Priority Data
Feb. 13, 2025 (JP) 2025-021668

(51) Int. Cl. G01S 17/894; H04N 23/68

(52) U.S. Cl. CPC G01S 17/894; H04N 23/6811; H04N 23/683

(57) ABSTRACT

In transformation from a device coordinate system to a world coordinate system, the labor is saved and the accuracy is increased. An information processing apparatus is provided that includes a first extraction unit that extracts three-dimensional feature point cloud data from three-dimensional point cloud data in a first coordinate system, a second extraction unit that extracts three or more specific points by matching the three-dimensional feature point cloud data with a three-dimensional model, and an alignment unit that aligns three or more specific points extracted by the second extraction unit in the first coordinate system with three or more specific points extracted in the second coordinate system.

### CROSS REFERENCE TO RELATED APPLICATIONS

This application is based upon and claims the benefit of priority from the prior Japanese Patent Application No. 2025-021668, filed on Feb. 13, 2025, the entire contents of which are incorporated herein by reference.

### FIELD

Embodiments relate to an information processing apparatus, a ranging system, an information processing method, and a program.

### BACKGROUND

Three-dimensional point cloud data acquired using a ranging apparatus in a device coordinate system may be transformed into data in a predetermined reference coordinate system (hereinafter, also referred to as a world coordinate system).

### BRIEF DESCRIPTION OF THE DRAWINGS

FIG. 1 is a block diagram illustrating a configuration of a ranging system according to a first embodiment of the present disclosure;

FIG. 2 is a diagram illustrating an alignment method according to the first embodiment of the present disclosure;

FIG. 3 is a diagram illustrating an example of first point cloud data in a device coordinate system;

FIG. 4 is a diagram illustrating a three-dimensional model according to the first embodiment of the present disclosure;

FIG. 5 is a diagram illustrating an example of second point cloud data in a world coordinate system;

FIG. 6 is a flowchart illustrating an operation of an information processing apparatus according to the first embodiment of the present disclosure;

FIG. 7 is a flowchart illustrating alignment processing according to the first embodiment of the present disclosure;

FIG. 8 is a diagram illustrating an example of the first point cloud data subject to correction of a mechanical error;

FIG. 9 is a diagram illustrating an example of the second point cloud data serving as a reference;

FIG. 10 is a block diagram illustrating a configuration of a ranging system according to a modification;

FIG. 11 is a block diagram illustrating a configuration of a ranging system according to a second embodiment of the present disclosure;

FIG. 12 is a diagram illustrating an example of first image data;

FIG. 13 is a diagram illustrating an example of an operation screen displayed to a user; and

FIG. 14 is a flowchart illustrating an operation of an information processing apparatus according to the second embodiment of the present disclosure.

### DETAILED DESCRIPTION

Hereinafter, an embodiment of the present invention will be described with reference to the drawings. Note that the following description does not exclude components or functions that are not illustrated or described.

According to the present embodiment, an information processing apparatus and a ranging system capable of saving labor and increasing accuracy in transformation from a device coordinate system to a world coordinate system are provided.

According to the present embodiment, an information processing apparatus is provided that includes:
a first extraction unit that extracts three-dimensional feature point cloud data from three-dimensional point cloud data in a first coordinate system;
a second extraction unit that extracts three or more specific points by matching the three-dimensional feature point cloud data with a three-dimensional model; and
an alignment unit that aligns three or more specific points extracted by the second extraction unit in the first coordinate system with three or more specific points extracted in the second coordinate system.

### First Embodiment

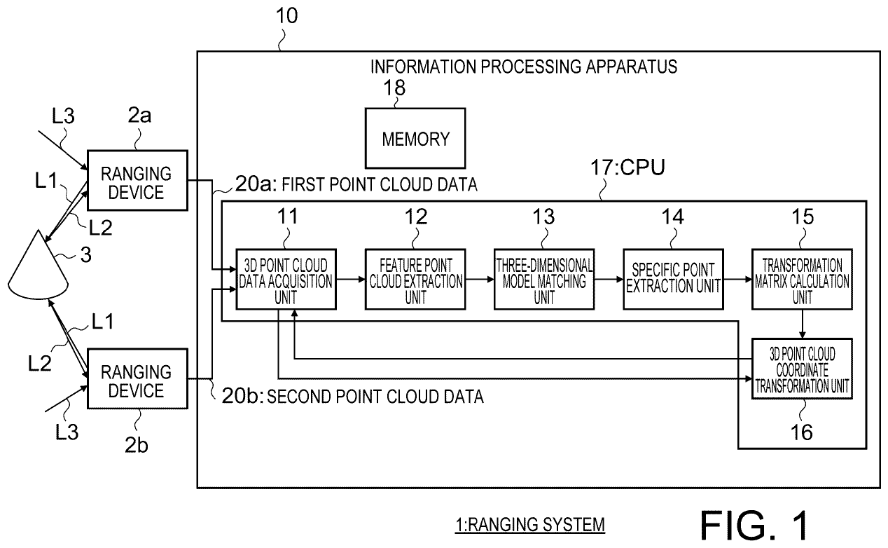

FIG. 1 is a block diagram illustrating a configuration of a ranging system 1 including an information processing apparatus 10 according to a first embodiment of the present disclosure. The ranging system 1 includes ranging apparatuses (ranging devices) 2a and 2b. The ranging apparatuses 2a and 2b perform ranging for a ranging target (object) 3. The ranging apparatuses 2a and 2b are, for example, light detection and ranging (LIDAR) systems.

The ranging apparatuses 2a and 2b perform ranging based on, for example, the time-of-flight (ToF) method. The ranging apparatuses 2a and 2b emit emission light L1 to the ranging target 3, and receive reflection light L2 that is the emission light L1 reflected by the ranging target 3. The ranging apparatuses 2a and 2b can acquire a distance to the ranging target 3 based on the emitted emission light L1 and the received reflection light L2. Note that the ranging apparatuses 2a and 2b may receive noise light (ambient light) L3.

The ToF method includes, for example, the direct ToF (dToF) method and the indirect ToF (iToF) method. In the dToF method, the distance to the ranging target 3 can be measured based on a time difference between the light emission timing of the emission light L1 and the light reception timing of the reflection light L2. In the iToF method, the distance to the ranging target 3 can be measured based on a phase shift between the light emission phase of the emission light L1 and the light reception phase of the reflection light L2. Either the dToF method or the iToF method may be applied to the ranging apparatuses 2a and 2b, and other ranging methods may be applied.

The ranging apparatuses 2a and 2b are arranged at different positions. In addition, the ranging apparatuses 2a and 2b are arranged such that one or more common ranging targets 3 are included in each other's field of view (FoV).

The ranging apparatus 2a outputs first point cloud data 20a based on a ranging result of the ranging target 3. The first point cloud data 20a has a plurality of pieces of point data plotted in the device coordinate system of the ranging apparatus 2a (first coordinate system) and including distance information to the ranging target 3. The first point cloud data 20a is data generated based on a light reception signal of reception light including the reflection light L2 received by the ranging apparatus 2a or data designed by simulating the light reception signal. Each piece of point data of the first point cloud data 20a represents, for example, a position where the ranging target 3 reflects light.

Similarly, the ranging apparatus 2b outputs second point cloud data 20b. The second point cloud data 20b has a plurality of pieces of point data plotted in the device coordinate system of the ranging apparatus 2b (second coordinate system) and including distance information to the ranging target 3. The second point cloud data 20b is data generated based on a light reception signal of reception light including the reflection light L2 received by the ranging apparatus 2b or data designed by simulating the light reception signal. In addition, as described later, the second point cloud data 20b may be data generated based on a light reception signal of reception light including the reflection light L2 received by the ranging apparatus 2a in an FoV different from that of the first point cloud data 20a or data designed by simulating the light reception signal.

The device coordinate system of the ranging apparatuses 2a and 2b is, for example, a three-dimensional coordinate system. In this case, the ranging apparatuses 2a and 2b can output the first point cloud data 20a and the second point cloud data 20b that are three-dimensional point cloud data (hereinafter, also referred to as 3D point cloud data).

An information processing apparatus 10 performs alignment between the first point cloud data 20a and the second point cloud data 20b. Hereinafter in the present specification, an example in which the device coordinate system of the ranging apparatus 2b is used as a world coordinate system will be described. That is, in the present specification, an example in which data of the first point cloud data 20a is transformed into data in the device coordinate system of the ranging apparatus 2b (world coordinate system) will be described.

The information processing apparatus 10 includes a 3D point cloud data acquisition unit (acquisition unit) 11, a feature point cloud extraction unit (first extraction unit) 12, a three-dimensional model matching unit 13, a specific point extraction unit (second extraction unit) 14, a transformation matrix estimation unit (generation unit) 15, and a 3D point cloud coordinate transformation unit (alignment unit) 16.

The 3D point cloud data acquisition unit 11 acquires the first point cloud data 20a and the second point cloud data 20b from the ranging apparatuses 2a and 2b.

The feature point cloud extraction unit 12 extracts three-dimensional feature point cloud data (hereinafter, also referred to as 3D feature point cloud data). The three-dimensional feature point cloud data is, for example, a set of a plurality of pieces of point data constituting a surface of a characteristic object (ranging target 3) or a reference surface (for example, a road surface, a floor surface, or the like) included in a predetermined ranging area.

The feature point cloud extraction unit 12 extracts some of point cloud data from the first point cloud data 20a as one or more pieces of first feature point cloud data. Similarly, the feature point cloud extraction unit 12 extracts one or more pieces of second feature point cloud data from the second point cloud data 20b. The first feature point cloud data and the second feature point cloud data are the above-described three-dimensional feature point cloud data.

The three-dimensional model matching unit 13 extracts one or more first three-dimensional models by performing matching processing between the one or more pieces of first feature point cloud data and a predetermined three-dimensional model. Similarly, the three-dimensional model matching unit 13 extracts one or more second three-dimensional models from the one or more pieces of second feature point cloud data.

The specific point extraction unit 14 extracts a plurality of first specific points and a plurality of second specific points from the one or more first three-dimensional models and the one or more second three-dimensional models, respectively. Details of the first specific point and the second specific point will be described later.

The transformation matrix estimation unit 15 generates a transformation matrix from coordinate information of the plurality of first specific points and coordinate information of the plurality of second specific points. For example, assume that a first specific point P0=(Px0, Py0, Pz0), a first specific point P1=(Px1, Py1, Pz1), and a first specific point P2=(Px2, Py2, Pz2) are extracted as the plurality of first specific points. In addition, assume that a second specific point Q0=(Qx0, Qy0, Qz0), a second specific point Q1=(Qx1, Qy1, Qz1), and a second specific point Q2=(Qx2, Qy2, Qz2) are extracted as the plurality of second specific points. A specific point matrix P can be formed using the first specific points P0 to P2. A specific point matrix Q can be formed using the second specific points Q0 to Q2. In this case, the transformation matrix estimation unit 15 can estimate a transformation matrix A that satisfies the following Formulas (1) and (2).

$$[ Math . 1 ]$$

$$Q = AP \qquad ( 1 )$$

$$( \begin{matrix}Qx 0 & Qx 1 & Qx 2 \\ Qy 0 & Qy 1 & Qy 2 \\ Qz 0 & Qz 1 & Qz 2\end{matrix} ) = A ( \begin{matrix}Px 0 & Px 1 & Px 2 \\ Py 0 & Py 1 & Py 2 \\ Pz 0 & Pz 1 & Pz 2\end{matrix} ) \qquad ( 2 )$$

The transformation matrix A above can be estimated, for example, by solving a least squares problem that minimizes J=(Q−AP)². As a method of estimating the transformation matrix A, for example, a method using singular value decomposition can be applied. Alternatively, the transformation matrix A may be estimated by a method using quaternions.

In the example described above, three first specific points and three second specific points are acquired. Alternatively, four or more first specific points and four or more second specific points may be acquired. Also in this case, the transformation matrix estimation unit 15 can estimate the transformation matrix A as with Formula (1). Note that the information processing apparatus 10 can improve the estimation accuracy of the transformation matrix A and improve the alignment accuracy by acquiring more first specific points and second specific points.

The 3D point cloud coordinate transformation unit 16 performs relative alignment between the 3D point cloud data in the first coordinate system and the 3D point cloud data in the second coordinate system using the estimated transformation matrix A. The 3D point cloud coordinate transformation unit 16 can transform the 3D point cloud data acquired from the ranging apparatus 2a into the 3D point cloud data in the world coordinate system (in the example of the present specification, the device coordinate system of the ranging apparatus 2b). For example, arbitrary point data Pn=(Px, Py, Pz) acquired by the ranging apparatus 2a can be transformed into point data Qn=(Qx, Qy, Qz) in the world coordinate system as expressed by the following Formula (3).

$$[ Math . 2 ]$$

$$( \begin{matrix}Qx \\ Qy \\ Qz\end{matrix} ) = A ( \begin{matrix}Px \\ Py \\ Pz\end{matrix} ) \qquad ( 3 )$$

The transformation matrix A that can be calculated by Formula (1) above is, for example, a rotation matrix. Without being limited thereto, the transformation matrix A may be a rigid transformation matrix. Also in this case, the transformation matrix A can be calculated as with the rotation matrix using the coordinate information of the first specific points P0 to P2 and the second specific points Q0 to Q2.

Formula (2) above illustrates an example in which the specific point matrices P and Q are constituted by the coordinates of the specific points. Without being limited thereto, the specific point matrices P and Q may include vectors. For example, the specific point matrix P may include a vector of a certain magnitude (for example, a unit vector) having information on a direction from the first specific point P0 to the first specific point P1. The information processing apparatus 10 can transform any vector extracted from the 3D point cloud data of the ranging apparatus 2a into a vector in the world coordinate system, using the transformation matrix A calculated from the specific point matrices P and Q including vectors.

Hereinafter in the present specification, an example in which the ranging system 1 includes two ranging apparatuses (that is, the ranging apparatuses 2a and 2b) will be described. Without being limited thereto, the ranging system 1 may include three or more ranging apparatuses. In this case, the ranging system 1 can use the 3D point cloud data acquired by any one ranging apparatus as the second point cloud data 20b. Thus, the 3D point cloud data acquired by another ranging apparatus can be transformed into the 3D point cloud data in the world coordinate system. In other words, the ranging system 1 can align the three or more specific points extracted in another coordinate system with (by using) the three or more specific points extracted in any one of a plurality of coordinate systems including the first coordinate system and the second coordinate system.

In addition, the ranging system 1 does not necessarily need to include two ranging apparatuses, that is, the ranging apparatuses 2a and 2b. The ranging system 1 may use the 3D point cloud data acquired by the ranging apparatus 2a in the past as the second point cloud data 20b in the world coordinate system. In this case, the ranging apparatus 2b can be omitted. For example, a mechanical error (camera shake or the like) of the ranging apparatus 2a may be corrected using the 3D point cloud data acquired by the ranging apparatus 2a in the past. In addition, in a case where the angle of view or the position of the ranging apparatus 2a can be dynamically changed, the 3D point cloud data acquired by the ranging apparatus 2a at a predetermined angle of view and position may be used as the second point cloud data 20b in the world coordinate system.

The information processing apparatus 10 may include a CPU 17. The operation of each function of the 3D point cloud data acquisition unit 11, the feature point cloud extraction unit 12, the three-dimensional model matching unit 13, the specific point extraction unit 14, the transformation matrix estimation unit 15, and the 3D point cloud coordinate transformation unit 16 described above is executed, for example, by the CPU 17.

The information processing apparatus 10 may include a memory 18. The memory 18 can store the 3D point cloud data, the 3D feature point cloud data, the first three-dimensional model or the second three-dimensional model, the first specific point or the second specific point, the transformation matrix A, the 3D point cloud data aligned by the 3D point cloud coordinate transformation unit 16, or the like. In addition, the memory 18 may store a predetermined three-dimensional model or a threshold for the matching with the three-dimensional model used for the matching processing by the three-dimensional model matching unit 13, a threshold for the extraction of the 3D feature point cloud data by the feature point cloud extraction unit 12, and the like. Note that the memory 18 may be configured as a temporary memory.

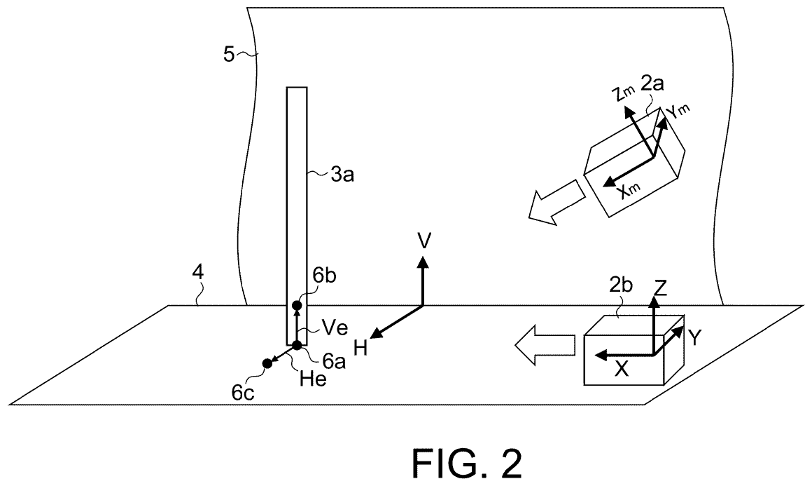

FIG. 2 is a diagram illustrating an alignment method according to the first embodiment of the present disclosure. FIG. 2 illustrates the ranging apparatuses 2a and 2b, a ranging target 3a, a reference surface 4, and a side wall 5.

The ranging target 3a is arranged on an arbitrary reference surface 4. The side wall 5 has, for example, a surface orthogonal to the reference surface 4. The reference surface 4 is, for example, a floor or the ground. The side wall 5 is, for example, an indoor wall or a side wall of a building or the like. In the example of FIG. 2, the ranging target 3a is a cylindrical object such as a lighting pole. Note that the shape of the ranging target 3a is arbitrary.

The ranging apparatus 2a has a device coordinate system Xm-Ym-Zm. The ranging apparatus 2b has a device coordinate system (world coordinate system) X-Y-Z. The coordinate axis Xm intersects with the coordinate axis X, the coordinate axis Ym intersects with the coordinate axis Y, and the coordinate axis Zm intersects with the coordinate axis Z. Note, not limited to the above, that at least one of the coordinate axes Xm, Ym, and Zm may be parallel to the corresponding coordinate axis X, Y, or Z.

The ranging apparatus 2b is arranged, for example, such that the coordinate axis Z is along a normal direction with respect to the reference surface 4. In addition, both the ranging apparatuses 2a and 2b are arranged such that the ranging target 3a, the reference surface 4, and the side wall 5 are included in the angle of view (FoV).

The information processing apparatus 10 extracts, for example, specific points 6a, 6b, and 6c from the ranging target 3a. The specific point 6a is, for example, an intersection of the central axis of the ranging target 3a and the reference surface 4. The specific point 6b is a point arranged apart from the specific point 6a in a normal direction V of the reference surface 4. The specific point 6b is, for example, a point arranged at the end point of a unit normal vector Ve starting from the specific point 6a. The specific point 6c is, for example, a point arranged apart from the specific point 6a in a normal direction H of the side wall 5 (that is, a direction horizontal to the reference surface 4). The specific point 6c is, for example, a point arranged at the end point of a unit normal vector He starting from the specific point 6a.

The information processing apparatus 10 may extract another specific point from the ranging target 3a. For example, the specific point may be extracted from the vertex, the center of gravity, or the like of the ranging target 3a. Alternatively, the information processing apparatus 10 may extract a normal vector or the like that enables the extraction of a new specific point by performing addition to the other specific point of the ranging target 3a.

The ranging apparatuses 2a and 2b can estimate the position coordinates of the specific points extracted above (in the example of FIG. 2, the specific points 6a to 6c). For example, the ranging apparatus 2a can acquire the coordinates of the first specific points P0 to P2 above from the coordinates of the specific points 6a to 6c viewed from the ranging apparatus 2a. In addition, the ranging apparatus 2b can acquire the coordinates of the second specific points Q0 to Q2 above from the coordinates of the specific points 6a to 6c viewed from the ranging apparatus 2b.

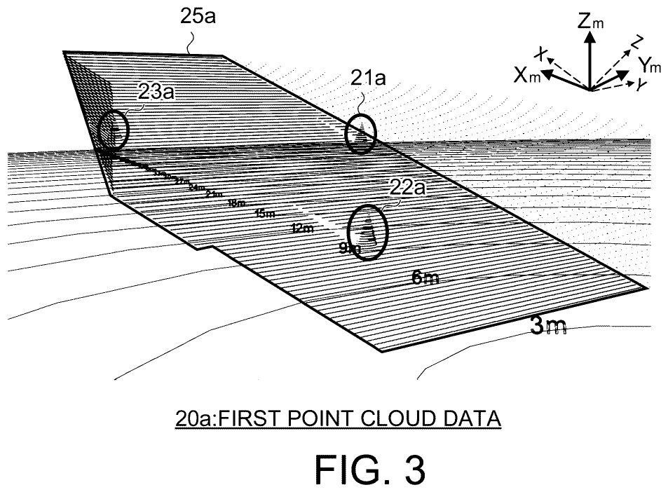

FIG. 3 is a diagram illustrating an example of the first point cloud data 20a. FIG. 3 illustrates first feature point cloud data 21a, 22a, 23a, and 25a.

As described above, the ranging apparatus 2a has the device coordinate system Xm-Ym-Zm. In addition, each piece of point data of the first point cloud data 20a is plotted on the device coordinate system Xm-Ym-Zm.

The first feature point cloud data 25a in FIG. 3 is, for example, point cloud data of the reference surface. On the reference surface, for example, the coordinate axis Z direction in the world coordinate system is the normal direction. The first feature point cloud data 21a to 23a are, for example, point cloud data of the object arranged on the reference surface.

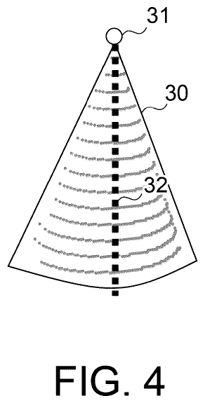

FIG. 4 is a diagram illustrating a three-dimensional model according to the first embodiment of the present disclosure. The feature point cloud extraction unit 12 can extract the first feature point cloud data 21a to 23a and the first feature point cloud data 25a from the first point cloud data 20a in FIG. 3. In addition, the three-dimensional model matching unit 13 approximates the first feature point cloud data 21a to 23a and the first feature point cloud data 25a to the first three-dimensional model such as a cone, a cylinder, or a plane (hereinafter, also simply referred to as a three-dimensional model). For example, RANSAC is used as the approximation method.

For example, the first feature point cloud data 21a to 23a in FIG. 3 can be approximated to a cone 30 as illustrated in FIG. 4. From the approximated cone 30, a vertex 31 and a central axis 32 can be extracted. That is, the cone 30 includes two pieces of information, that is, information on the position of the vertex 31 and information on the vector of the central axis 32.

The specific point extraction unit 14 can extract the vertex 31 as the first specific point (hereinafter, also simply referred to as a specific point). In addition, the specific point extraction unit 14 can extract a point obtained by adding the vector of the central axis 32 to the vertex 31 or the like as the specific point. As described above, the specific point extraction unit 14 can extract two pieces of information, that is, the information on the position of the vertex 31 and the information on the vector of the central axis 32, by extracting at least two specific points.

The specific point extraction unit 14 can approximate the first feature point cloud data 25a to a plane. The three-dimensional model of the plane includes a normal vector with respect to the plane. For example, the specific point extraction unit 14 may extract a point obtained by adding the normal vector of a certain magnitude (for example, the unit normal vector) with respect to the plane to the vertex 31 in FIG. 4 as the specific point. Thus, the specific point including information on the normal vector can be extracted.

In addition, from the first feature point cloud data approximated to a cylinder, a point obtained by adding a vector on the central axis of the cylinder to a specific point extracted from another ranging target can be extracted as the specific point. Thus, the specific point including information on the central axis vector of the cylinder can be extracted.

In addition to the above, the first feature point cloud data may be approximated to a three-dimensional model such as a polygonal pyramid, a polygonal prism, a truncated cone, a truncated polygonal pyramid, a sphere, a polyhedron, or a hemisphere. For example, from the polygonal pyramid, at least two specific points including the information on the vertex and the central axis vector can be extracted as with the cone. From the polygonal prism, the truncated cone, and the truncated polygonal pyramid, at least one specific point including the information on the central axis vector can be extracted as with the cylinder. From the sphere and the polyhedron, for example, at least one specific point including information on the center of gravity can be extracted. From the hemisphere, for example, at least one specific point including information on the center can be extracted. Note that the specific point may include not only a uniquely specified location in a three-dimensional space but also a vector uniquely specified in the three-dimensional space (for example, an axis vector or a normal vector of the three-dimensional model).

In addition, the three-dimensional model matching unit 13 may match the first feature point cloud data with the shape of a predetermined member or the like (for example, a gear, a screw, or the like). The specific point extraction unit 14 may extract one or more specific points corresponding to the shape of the member or the like. The shape of the member or the like and the position information of the specific point extracted from the member may be stored in a storage apparatus (for example, the memory 18) or the like inside or outside the information processing apparatus 10.

The specific point extraction unit 14 may extract the specific point from the point data included in the first point cloud data 20a. In addition, the specific point extraction unit 14 may extract a specific point not included in the point data in the first point cloud data 20a. That is, the specific point extraction unit 14 may extract a virtual point (for example, the vertex, a point on the central axis, or the like of the three-dimensional model) estimated from the three-dimensional model as the specific point.

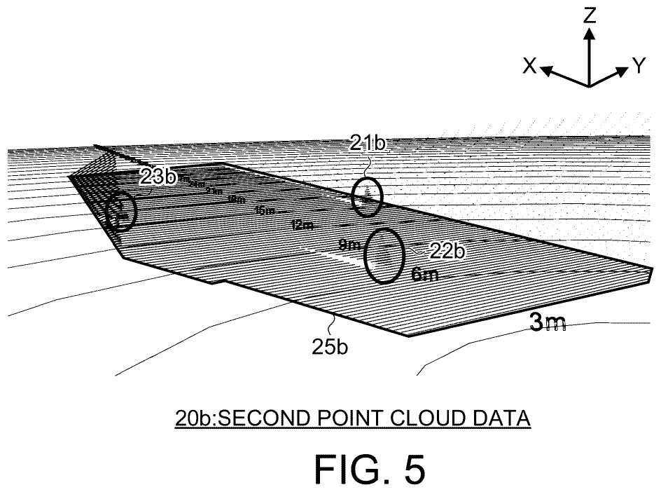

FIG. 5 is a diagram illustrating an example of the second point cloud data 20b. The second point cloud data 20b includes second feature point cloud data 21b, 22b, 23b, and 25b corresponding to the first feature point cloud data 21a, 22a, 23a, and 25a in FIG. 3, respectively. The three-dimensional model matching unit 13 approximates the second feature point cloud data 21b to 23b to the second three-dimensional model such as a cone, a cylinder, a truncated cone, a polygonal pyramid, a polygonal prism, a truncated polygonal pyramid, a sphere, a polyhedron, a hemisphere, or a plane. The specific point extraction unit 14 extracts the second specific point corresponding to the first specific point from the second three-dimensional model, as with the first three-dimensional model.

In a case where the first specific point and the second specific point have information on the central axis vector of the three-dimensional model (object), the 3D point cloud coordinate transformation unit 16 can align the first point cloud data 20a with the second point cloud data 20b using the transformation matrix A such that the inclinations of the central axes of the objects substantially coincide. Similarly, in a case where the first specific point and the second specific point have information on the center of gravity, the vertex, or the normal vector with respect to the reference surface or the like of the three-dimensional model, the 3D point cloud data can be aligned such that the positions of the center of gravity or the vertices of the object, or the inclinations of the normal vectors with respect to the reference surface, or the like substantially coincide with each other.

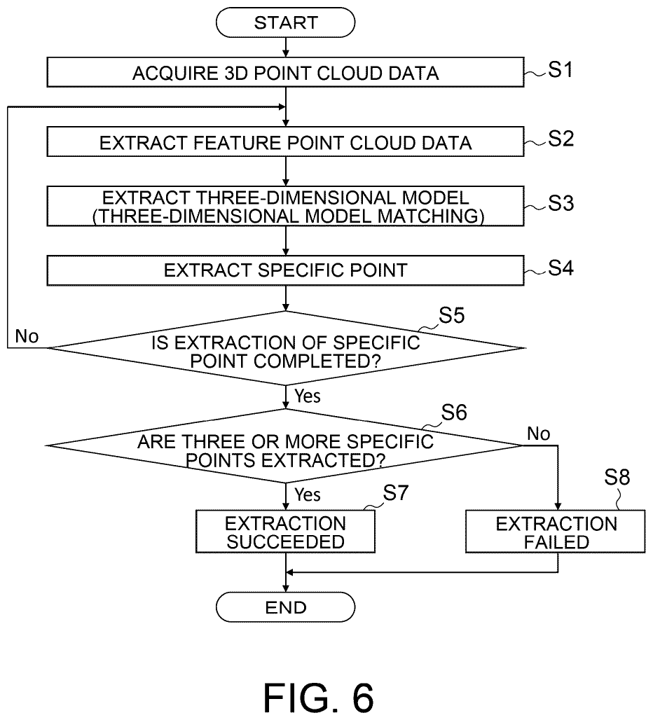

FIG. 6 is a flowchart illustrating an operation of the information processing apparatus 10 according to the first embodiment of the present disclosure. Hereinafter, an example in which the first specific point is extracted from the first point cloud data 20a will be described. Note that a method of extracting the second specific point from the second point cloud data 20b is also the same as that in the example described below.

First, the 3D point cloud data acquisition unit 11 acquires the 3D point cloud data (step S1).

Subsequently, as illustrated in FIG. 3, the feature point cloud extraction unit 12 searches the first point cloud data 20a to check if the first feature point cloud data to be matched with the first three-dimensional model is included. If the first feature point cloud data is discovered, the feature point cloud extraction unit 12 extracts the first feature point cloud data (step S2).

As illustrated in FIG. 4, the three-dimensional model matching unit 13 approximates the first feature point cloud data extracted in step S2 to the first three-dimensional model (three-dimensional model matching). As a result, the three-dimensional model matching unit 13 can extract the first three-dimensional model (step S3).

As illustrated in FIG. 4, the specific point extraction unit 14 extracts one or more first specific points from the first three-dimensional model generated in step S3 (step S4).

Subsequently, the information processing apparatus 10 determines whether or not the extraction of the first feature point cloud data has been completed (step S5). In step S5, for example, the feature point cloud extraction unit 12 determines whether there is first feature point cloud data that has not yet been extracted in the first point cloud data 20a. If there is the first feature point cloud data that has not yet been extracted, the feature point cloud extraction unit 12 may extract the first feature point cloud data in step S2. In addition, the information processing apparatus 10 may determine whether a sufficient number of first specific points have been extracted at the time of step S5. If the sufficient number of first specific points have been extracted, the information processing apparatus 10 does not need to newly extract the first feature point cloud data.

After executing the processing of steps S2 to S5 once or more, the information processing apparatus 10 determines whether or not three or more first specific points have been acquired (step S6). If the three or more first specific points can be acquired, it may be determined that the extraction of the first specific points has succeeded (step S7).

If three or more first specific points cannot be acquired, it may be determined that the extraction of the first specific points has failed (step S8). In this case, the first point cloud data 20a may be reacquired by changing the angle of view of the ranging apparatus 2a, or the extraction processing, the extraction threshold, or the like of the first feature point cloud data in step S2 may be changed. Alternatively, the processing, the threshold, or the like of the approximation to the first three-dimensional model in step S3 may be changed.

A threshold for the determination in step S6 can be adjusted according to the number of unknowns in the transformation matrix A. For example, in a case where the transformation matrix A is a rigid transformation matrix, it may be determined in step S6 whether or not four or more first specific points have been acquired. In addition, the threshold for the determination in step S6 may be arbitrarily adjusted based on the required alignment accuracy. That is, in a case where four or more first specific points cannot be acquired, in a case where five or more first specific points cannot be acquired, or in other similar cases, the information processing apparatus 10 may determine that the extraction of the first specific points has failed.

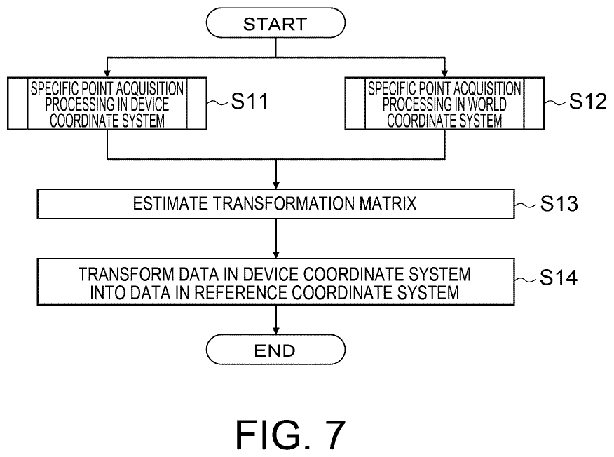

FIG. 7 is a flowchart illustrating alignment processing according to the first embodiment of the present disclosure. First, the information processing apparatus 10 acquires the specific point in the device coordinate system (that is, the first specific point) by the method described with reference to FIG. 6 (step S11). Similarly, the information processing apparatus 10 acquires the specific point in the world coordinate system (that is, the second specific point) (step S12).

The transformation matrix estimation unit 15 estimates the transformation matrix A based on the first specific point and the second specific point acquired in steps S11 and S12 (step S13). Specifically, the transformation matrix A can be estimated by solving the above-described Formula (1) using a method such as singular value decomposition.

The 3D point cloud coordinate transformation unit 16 can coordinate-transform the 3D point cloud data output by the ranging apparatus 2a using the transformation matrix A estimated in step S13 (step S14). Specifically, the 3D point cloud data of the ranging apparatus 2a can be transformed into (that is, aligned with) the 3D point cloud data in the world coordinate system using the above-described Formula (3) or the like.

The alignment above makes it possible to combine, register, or compare the 3D point cloud data of the ranging apparatuses 2a and 2b. In addition, the 3D point cloud data of a plurality of ranging apparatuses transformed into data in the world coordinate system may be combined.

The ranging system 1 can be used in various purposes. For example, the ranging system 1 may be used to correct a mechanical error (for example, camera shake correction) of the ranging apparatus 2a. That is, a mechanical position error of the first point cloud data 20a may be corrected based on the second point cloud data 20b acquired by the ranging apparatus 2a in the past. The above-described second point cloud data 20b acquired in the past may be stored in, for example, the memory 18.

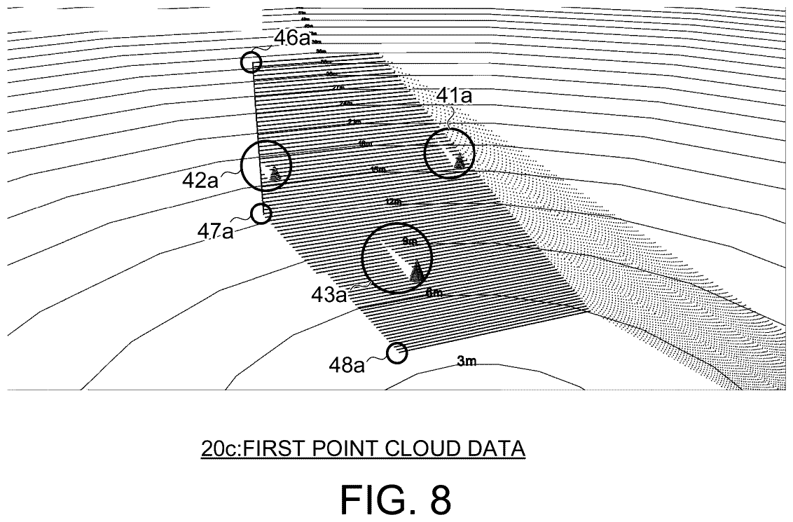

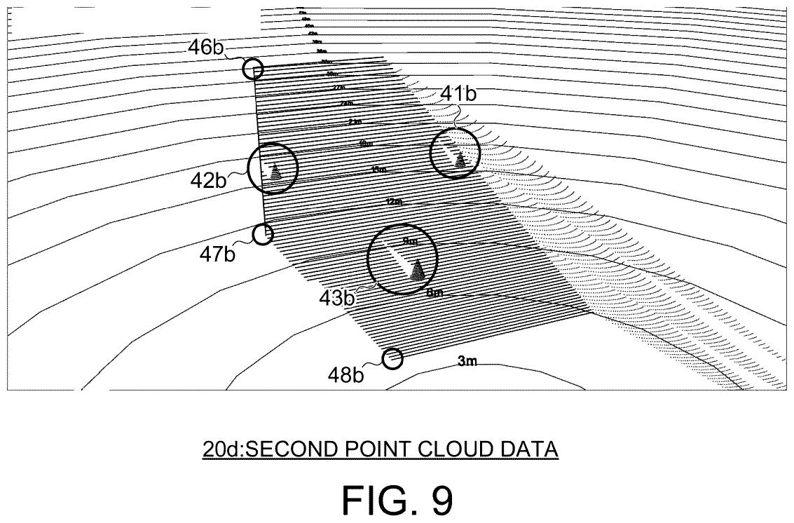

FIG. 8 is a diagram illustrating an example of first point cloud data 20c subject to the correction of the mechanical error. FIG. 9 is a diagram illustrating an example of second point cloud data 20d serving as a reference. The first point cloud data 20c is, for example, 3D point cloud data acquired by, for example, the ranging apparatus 2a. The second point cloud data 20d is, for example, 3D point cloud data acquired by the ranging apparatus 2a in the past before the acquisition of the first point cloud data 20c. The ranging apparatus 2a has a misalignment in the FoV between the first point cloud data 20c and the second point cloud data 20d.

From the first point cloud data 20c in FIG. 8, first feature point cloud data 41a, 42a, and 43a can be extracted as with the first point cloud data 20a in FIG. 3. From the second point cloud data 20d in FIG. 9, second feature point cloud data 41b, 42b, and 43b corresponding to the first feature point cloud data 41a, 42a, and 43a can be extracted. Thus, the mechanical error of the first point cloud data 20c can be corrected by the method illustrated in FIGS. 6 and 7.

As a comparative example, an example in which the mechanical error of the first point cloud data 20c is corrected using iterative closest point (ICP) will be considered. First, as a first comparative example, a case where ICP is applied to the entire point cloud of the first point cloud data 20c and the second point cloud data 20d will be considered. In this case, a transformation matrix that represents nearest neighbors between substantially all the point data of the first point cloud data 20c and substantially all the point data of the second point cloud data 20d is searched for. As a result, the calculation amount increases in the first comparative example.

In addition, in the method of the first comparative example, the boundary point of the FoV of the ranging apparatus 2a may affect the alignment accuracy. Specifically, boundary points 46a, 47a, and 48a of the FoV are illustrated in FIG. 8. In addition, boundary points 46b, 47b, and 48b corresponding to the boundary points 46a, 47a, and 48a are illustrated in FIG. 9. In the method of the first comparative example, since alignment between the boundary points 46a to 48a and the boundary points 46b to 48b is weighted, alignment between the first feature point cloud data 41a to 43a and the second feature point cloud data 41b to 43b may be less weighted. As a result, the accuracy of the alignment between the first feature point cloud data 41a to 43a and the second feature point cloud data 41b to 43b may be reduced.

In contrast to the first comparative example, the method in FIGS. 6 and 7 can search for the transformation matrix A that minimizes a difference between the extracted first specific point and second specific point. As a result, in the method in FIGS. 6 and 7, the calculation amount can be reduced as compared with the first comparative example.

In addition, in the method in FIGS. 6 and 7, the boundary points 46a to 48a and 46b to 48b do not affect the calculation of the transformation matrix A. Therefore, in the method in FIGS. 6 and 7, the first feature point cloud data 41a to 43a and the second feature point cloud data 41b to 43b can be aligned with high accuracy as compared with the first comparative example.

As a second comparative example, a method in which ICP is applied to the first feature point cloud data 41a to 43a and the second feature point cloud data 41b to 43b extracted in advance (hereinafter, also collectively referred to as feature point cloud data) will be considered. In the method of the second comparative example, in a case where point data in the feature point cloud data is sparse, the accuracy of ICP may be reduced.

In addition, in the feature point cloud data, point data of the surface of the object facing the ranging apparatus (hereinafter, also referred to as a front surface) may be dense. On the other hand, point data of the surface of the object opposite to the front surface (hereinafter, also referred to as a back surface) may be sparse. In ICP, in a case where the point data of the back surface is sparse, the accuracy of alignment between objects may be reduced.

In contrast to the second comparative example, in the method in FIGS. 6 and 7, a method with higher accuracy than ICP (for example, RANSAC or the like) can be applied to the three-dimensional model matching of the feature point cloud data. As a result, even in a case where the point data of the feature point cloud data is sparse, in a case where the point data of the back surface of the object is sparse, or in other similar cases, the feature point cloud data can be matched with the three-dimensional model with high accuracy.

In addition, in the method in FIGS. 6 and 7, the specific point is acquired from the central axis or the like of the three-dimensional model. The central axis or the like may be able to be estimated from the shape or the like of the front surface of the object even in a case where information on the shape of a part of the object (for example, the shape of the back surface) is missing from the feature point cloud data. Therefore, in the method in FIGS. 6 and 7, the specific point can be acquired with high accuracy, that is, the alignment can be performed with high accuracy as compared with the second comparative example.

As described above, in the method in FIGS. 6 and 7, alignment can be performed with higher accuracy and a lower calculation amount than in the method using ICP according to the comparative example.

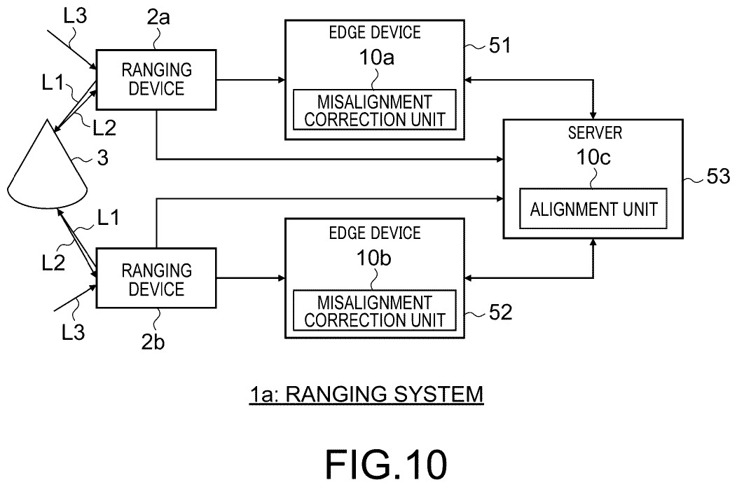

FIG. 10 is a block diagram illustrating a configuration of a ranging system 1a according to a modification. The ranging system 1a in FIG. 10 includes edge devices 51 and 52 and a server 53. The edge device 51 includes a misalignment correction unit 10a. The edge device 52 includes a misalignment correction unit 10b. The server 53 includes an alignment unit 10c. The misalignment correction units 10a and 10b and the alignment unit 10c have the configuration similar to that of the information processing apparatus 10 in FIG. 1.

The misalignment correction unit 10a corrects the mechanical error of the 3D point cloud data output by the ranging apparatus 2a. That is, the misalignment correction unit 10a corrects the first point cloud data 20a acquired by the ranging apparatus 2a using the second point cloud data 20b acquired by the ranging apparatus 2a in the past. The misalignment correction unit 10a may mechanically drive the ranging apparatus 2a based on the estimated transformation matrix A to correct the position or FoV. Similarly, the misalignment correction unit 10b corrects the mechanical position error of the ranging apparatus 2b. For example, the misalignment correction units 10a and 10b may correct the mechanical error of the 3D point cloud data every time the ranging apparatuses 2a and 2b output the 3D point cloud data.

The alignment unit 10c performs alignment between a plurality of ranging apparatuses including the ranging apparatuses 2a and 2b. The alignment unit 10c uses, for example, the device coordinate system of the ranging apparatus 2b as the world coordinate system. As a result, the plurality of ranging apparatuses such as the ranging apparatus 2a can be aligned with the world coordinate system. The alignment unit 10c may perform alignment between the plurality of ranging apparatuses at the time of initialization of the ranging system 1a. Alternatively, alignment between the plurality of ranging apparatuses may be performed at regular intervals.

The alignment unit 10c may acquire the first point cloud data 20a and the second point cloud data 20b from the edge devices 51 and 52, respectively, or from the ranging apparatuses 2a and 2b, respectively.

The misalignment correction unit 10a may acquire or store the transformation matrix A estimated by the alignment unit 10c. The misalignment correction unit 10a may align each of a plurality of pieces of first point cloud data 20a acquired by the ranging apparatus 2a (for example, at regular intervals) with the world coordinate system using the transformation matrix A estimated by the alignment unit 10c.

A plurality of modifications are conceivable for the ranging system 1. For example, the ranging system 1 may include a storage apparatus (for example, the memory 18) that stores the second point cloud data 20b acquired by the ranging apparatus 2a in the past, a communication apparatus that acquires the second point cloud data 20b from an external storage apparatus or the like, or the like. These storage apparatuses, communication apparatuses, and the like may be arranged inside the information processing apparatus 10.

The second point cloud data 20b may be output by an apparatus other than the ranging apparatuses 2a and 2b. For example, as the second point cloud data 20b, 3D point cloud data formed from survey results or design data of known feature points, or 3D point cloud data formed by a technique such as digital twin may be used.

In addition, the second specific point is not necessarily extracted by the specific point extraction unit 14. For example, the specific point extraction unit 14 may acquire the second specific point stored in a predetermined storage apparatus (for example, the memory 18) or the like. For the second specific point, a specific point acquired by the specific point extraction unit 14 or the like in the past may be used, or the second specific point may be formed from known survey results or design data. In this case, the processing of acquiring the second point cloud data 20b, the second three-dimensional model, and the second feature point cloud data may be omitted. Similarly, for the second three-dimensional model or the second feature point cloud data, data acquired from the predetermined storage apparatus (for example, the memory 18) or the like, or data formed from known survey results or design data may be used.

As described above, the information processing apparatus 10 according to the first embodiment of the present disclosure can save labor and increase accuracy in transformation from the device coordinate system to the world coordinate system.

Specifically, the information processing apparatus 10 extracts some of feature point cloud data from the 3D point cloud data acquired by the ranging apparatus. The information processing apparatus 10 approximates the extracted feature point cloud data to the three-dimensional model, and estimates the specific point from the vertex, the central axis, or the like of the three-dimensional model. The information processing apparatus 10 estimates the transformation matrix A from the specific point and uses the transformation matrix A for the alignment between the ranging apparatuses.

The number of pieces of point data of the specific points is remarkably smaller than the number of pieces of point data of the 3D point cloud data acquired by the ranging apparatus. By searching for the transformation matrix A using the specific point, the information processing apparatus 10 can greatly reduce the calculation amount as compared with the method that iteratively searches for the transformation matrix using the 3D point cloud data.

In addition, the information processing apparatus 10 can estimate the specific point from the central axis or the like of the three-dimensional model. The information processing apparatus 10 can estimate the specific point with high accuracy without being affected by sparseness and denseness of point data of the three-dimensional model and missing of the back surface shape or the like of the three-dimensional model. Furthermore, the information processing apparatus 10 is not affected by the boundary point of the FoV. Therefore, the information processing apparatus 10 can perform alignment with high accuracy.

### Second Embodiment

In step S2 in FIG. 6, the feature point cloud data is extracted from the 3D point cloud data. The feature point cloud data can be extracted, for example, by determining whether or not the 3D point cloud data can be comprehensively matched with the three-dimensional model, but the calculation amount is large in this method. In a second embodiment of the present disclosure, a method for extracting the feature point cloud data with a small calculation amount will be described.

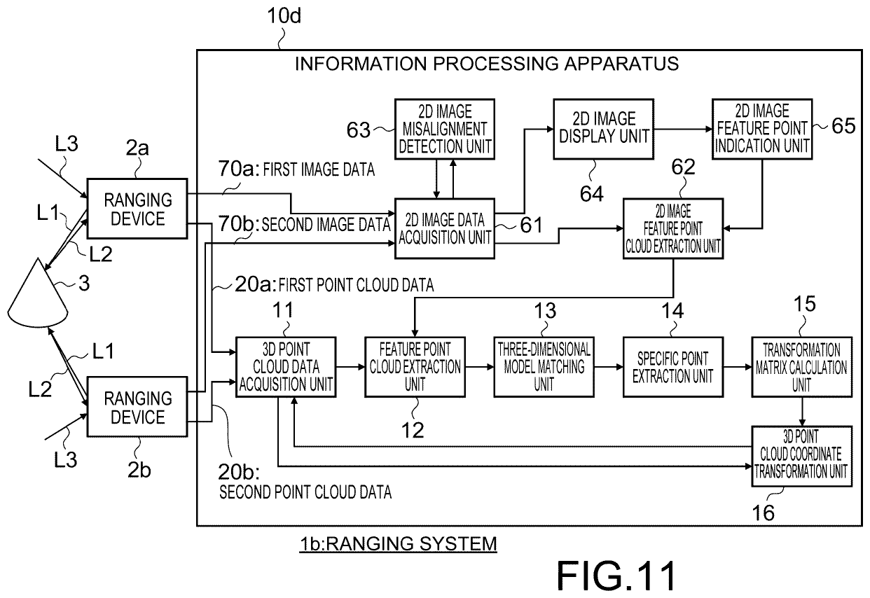

FIG. 11 is a block diagram illustrating a configuration of a ranging system 1b according to the second embodiment of the present disclosure. An information processing apparatus 10d in FIG. 11 includes a 2D image data acquisition unit 61 and a 2D image feature point cloud extraction unit (third extraction unit) 62 in addition to the components in FIG. 1.

In FIG. 11, the CPU 17 and the memory 18 are omitted from the illustration. Note that the functions of the 2D image data acquisition unit 61 and the 2D image feature point cloud extraction unit 62 are executed by, for example, the CPU 17 in FIG. 1.

The 2D image data acquisition unit 61 acquires two-dimensional image data (hereinafter, also referred to as 2D image data) of first image data 70a corresponding to the first point cloud data 20a and second image data 70b corresponding to the second point cloud data 20b. The first image data 70a can be acquired from, for example, the ranging apparatus 2a. The second image data 70b can be acquired from, for example, the ranging apparatus 2b. That is, the first point cloud data 20a and the first image data 70a are data in the same FoV and data in the same first coordinate system. In addition, the second point cloud data 20b and the second image data 70b are data in the same FoV and data in the same second coordinate system. The ranging apparatuses 2a and 2b can detect the distance to the object based on at least one of the 3D point cloud data and the 2D image data. The 2D image data may be stored in, for example, the memory 18 in FIG. 1.

The first image data 70a has a plurality of pieces of pixel data corresponding to a plurality of pieces of point data in the first point cloud data 20a. For example, each piece of point data of the first point cloud data 20a corresponds to each piece of pixel data of the first image data 70a on a one-to-one basis. For example, the ranging apparatus 2a may output a plurality of pixel signals based on the received reflection light L2. One piece of point data of the first point cloud data 20a and one piece of pixel data of the first image data 70a may be generated based on one pixel signal. That is, the first image data 70a is data generated based on luminance information of the light reception signal of reception light including the reflection light L2 received by the ranging apparatus 2a or data designed by simulating the light reception signal.

Similarly, the second image data 70b has a plurality of pieces of pixel data corresponding to a plurality of pieces of point data of the second point cloud data 20b. The second image data 70b is, for example, data generated based on luminance information of the light reception signal of reception light including the reflection light L2 received by the ranging apparatus 2b (or received by the ranging apparatus 2a in a FoV different from that of the first image data 70a), or data designed by simulating the light reception signal.

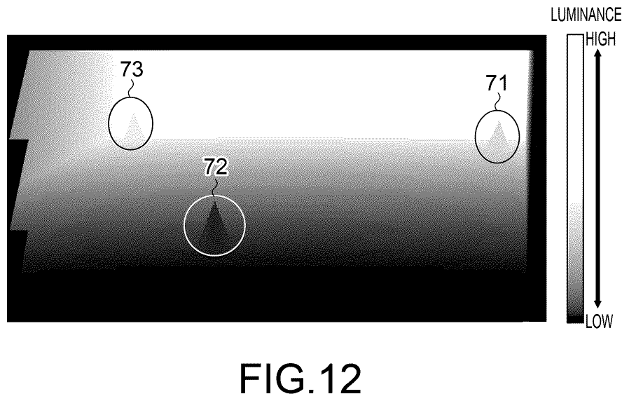

FIG. 12 is a diagram illustrating an example of the first image data 70a. The first image data 70a in FIG. 12 corresponds to, for example, the first point cloud data 20a in FIG. 3. Note that the overall brightness and contrast of the actual first image data 70a are adjusted in FIG. 12 for the sake of illustration.

As illustrated in FIG. 12, each of the plurality of pieces of pixel data in the first image data 70a has luminance information of the received reflection light L2. That is, the first image data 70a has luminance distribution.

The first image data 70a in FIG. 12 has feature point cloud data 71, 72, and 73 with luminance different from that of the surroundings. The feature point cloud data 71, 72, and 73 correspond to the first feature point cloud data 21a, 22a, and 23a in FIG. 3, respectively.

The 2D image feature point cloud extraction unit 62 in FIG. 11 extracts the feature point cloud data in the first image data 70a (for example, the feature point cloud data 71 to 73 in FIG. 12) by performing image processing. In addition, the feature point cloud extraction unit 12 in FIG. 11 can extract the first feature point cloud data by extracting point data corresponding to the feature point cloud data extracted by the 2D image feature point cloud extraction unit 62 from the plurality of pieces of point data in the first point cloud data 20a. Similarly, the 2D image feature point cloud extraction unit 62 and the feature point cloud extraction unit 12 in FIG. 11 can extract the second feature point cloud data from the second point cloud data 20b based on the feature point cloud data extracted from the second image data 70b.

As described above, the 2D image feature point cloud extraction unit 62 acquires the feature point cloud data of the 2D image data (hereinafter, also referred to as 2D feature point cloud data) by performing image processing on the 2D image data acquired from the ranging apparatus. Based on the 2D feature point cloud data, the feature point cloud extraction unit 12 can extract the 3D feature point cloud data from the 3D point cloud data with high accuracy and a low calculation amount.

Note that the feature point cloud extraction unit 12 may extract some of the 3D point cloud data corresponding to the 2D feature point cloud data as the 3D feature point cloud data. Alternatively, the feature point cloud extraction unit 12 may extract the 3D point cloud data corresponding to the 2D feature point cloud data and the 3D point cloud data arranged around the 3D point cloud data as the 3D feature point cloud data.

As a comparative example, a case where each piece of point data of the 3D point cloud data has luminance information will be considered. Even in this case, the 3D feature point cloud data can be extracted from the 3D point cloud data based on the luminance information.

However, in the method of the comparative example, it may be difficult to distinguish between point cloud data such as on the reference surface (for example, the ground) and point cloud data that can be matched with the three-dimensional model. On the other hand, in the method of the second embodiment of the present disclosure, the 2D feature point cloud data and the 3D feature point cloud data can be extracted by excluding the effects of the reference surface through the image processing on the 2D image data. Note that the method of the above-described comparative example may be applied to the alignment method according to the second embodiment of the present disclosure.

The information processing apparatus 10d in FIG. 11 may include a 2D image misalignment detection unit 63. The 2D image misalignment detection unit 63 compares the 2D image data acquired by the 2D image data acquisition unit 61 (hereinafter, also referred to as the first image data) from the ranging apparatus (for example, the ranging apparatus 2a) with the 2D image data acquired by the ranging apparatus in the past (hereinafter, also referred to as the second image data). The second image data may be stored in, for example, the memory 18 in FIG. 1.

The 2D image misalignment detection unit 63 can detect a misalignment in pixel position between the second image data and the first image data, for example, by performing processing such as camera shake correction. That is, the 2D image misalignment detection unit 63 can extract the 2D feature point cloud data in the first image data (hereinafter, also referred to as the first 2D feature point cloud data) based on the misalignment in pixel position detected and the 2D feature point cloud data (hereinafter, also referred to as the second 2D feature point cloud data) extracted from the second image data. As a result, the first 2D feature point cloud data can be extracted with a low calculation amount as compared with the case where the first 2D feature point cloud data is extracted directly from the first image data.

The 2D feature point cloud data may be extracted by a user operation. For example, the information processing apparatus 10d in FIG. 11 may have a 2D image display unit 64 and a 2D image feature point indication unit 65. The 2D image display unit 64 displays the 2D image data acquired from the ranging apparatus to a user. The 2D image feature point indication unit 65 indicates the 2D feature point cloud data to be extracted based on user input.

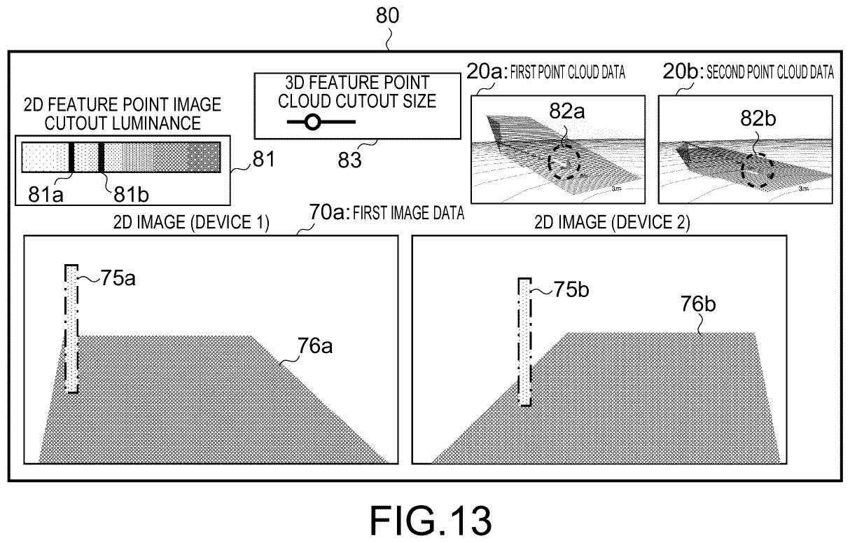

FIG. 13 is a diagram illustrating an example of an operation screen 80 displayed by the 2D image display unit 64 to the user. Either one or both of the first image data 70a and the second image data 70b (for example, both) are displayed on the operation screen 80. In addition, the operation screen 80 includes a cutout luminance indication unit 81.

The first image data 70a in FIG. 13 includes an object 75a and a reference surface 76a with luminance different from the luminance of the object 75a. The second image data 70b includes an object 75b having substantially the same luminance as that of the object 75a and a reference surface 76b having substantially the same luminance as that of the reference surface 76a.

The cutout luminance indication unit 81 can indicate, for example, an upper limit luminance 81a and a lower limit luminance 81b. That is, the cutout luminance indication unit 81 can indicate a luminance range to be cut out. Note that the cutout luminance indication unit 81 may be configured to indicate either the upper limit luminance 81a or the lower limit luminance 81b.

The user can adjust the luminance range of the cutout luminance indication unit 81, for example, such that the luminance of the objects 75a and 75b is included in the luminance range and the luminance of the reference surfaces 76a and 76b is not included in the luminance range. Thus, the user can extract the objects 75a and 75b as the 2D feature point cloud data (hereinafter, also referred to as a cutout target) from the first image data 70a and the second image data 70b, respectively.

Note that the user may directly extract the cutout target (for example, the objects 75a and 75b) from the first image data 70a and the second image data 70b by clicking, range indication, or other operations.

Either one or both of the first point cloud data 20a and the second point cloud data 20b (for example, both) may be displayed on the operation screen 80. In the first point cloud data 20a and the second point cloud data 20b, cutout ranges 82a and 82b corresponding to the cutout target indicated by the user may be displayed. The feature point cloud extraction unit 12 can extract point cloud data in the cutout ranges 82a and 82b as the 3D feature point cloud data.

The operation screen 80 may include a cutout size indication unit 83. The cutout size indication unit 83 can indicate the sizes of the cutout ranges 82a and 82b.

The user may directly indicate or change the cutout ranges 82a and 82b by clicking, dragging, or the like. Thus, the user can directly indicate the 3D feature point cloud data. In this case, the first image data 70a, the second image data 70b, the cutout luminance indication unit 81, and the like may be omitted from the operation screen 80.

The operation screen 80 may be displayed on a display apparatus (for example, a display) arranged inside or outside the information processing apparatus 10d. Alternatively, the user may acquire the operation screen 80 from the information processing apparatus 10d or the like using an arbitrary device (for example, a notebook computer, a smartphone, or the edge device 51 in FIG. 10, or the like). That is, the operation screen 80 may be displayed on any device. The processing of the operation screen 80 may be executed by the CPU 17 in FIG. 1. In addition, setting information (configuration) of the operation screen 80 may be stored in the memory 18.

As described above, the 2D image feature point cloud extraction unit 62 can extract the 2D feature point cloud data based on at least one of the luminance information of the 2D image data and the instruction information of the user. Alternatively, the 2D image feature point cloud extraction unit 62 may extract the 2D feature point cloud data based on design information on the 2D image data or the like. In addition, the feature point cloud extraction unit 12 can extract the 3D feature point cloud data based on at least one of the luminance information of the 2D feature point cloud data and the instruction information of the user. Furthermore, as in the above-described comparative example, the 3D feature point cloud data may be extracted based on the luminance information of the 3D point cloud data, or the 3D feature point cloud data may be extracted based on the design information of the 3D point cloud data or the like.

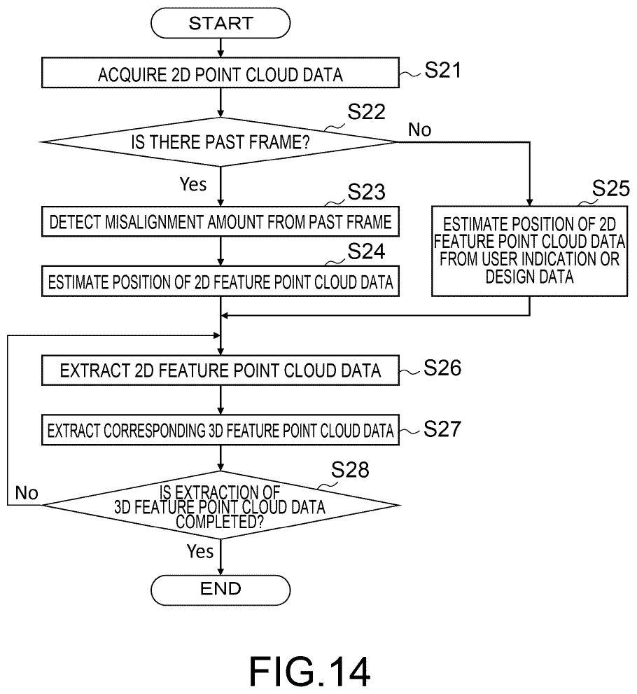

FIG. 14 is a flowchart illustrating an operation of the information processing apparatus 10d according to the second embodiment of the present disclosure. Hereinafter, an example in which the 3D feature point cloud data is extracted from the first point cloud data 20a will be described. Note that a method of extracting the 3D feature point cloud data from the second point cloud data 20b is also the same as the example described below.

First, the 2D image data acquisition unit 61 acquires the first image data 70a from the ranging apparatus 2a (step S21).

Subsequently, the 2D image data acquisition unit 61 determines whether there is a past frame of the first image data 70a, that is, the first image data 70a output by the ranging apparatus 2a in the past (step S22).

If there is the past frame, the 2D image misalignment detection unit 63 performs processing of detecting the misalignment amount of the pixel position (for example, camera shake correction processing) between the first image data 70a acquired in step S1 and the past frame (step S23).

Subsequently, the 2D image misalignment detection unit 63 estimates the pixel position of the 2D feature point cloud data in the first image data 70a from the misalignment amount detected in step S23 (step S24). For example, the pixel position of the 2D feature point cloud data in the first image data 70a can be estimated by adding the misalignment amount detected in step S23 to the pixel position of the 2D feature point cloud data detected from the past frame.

In step S22, if there is no past frame, the information processing apparatus 10d estimates the pixel position of the 2D feature point cloud data from user indication, design data, or the like (step S25). In the case of user indication, for example, the operation screen 80 in FIG. 13 may be used. The case where there is no past frame is assumed to be, for example, a case where the ranging system 1b is initialized.

Subsequently, the 2D image feature point cloud extraction unit 62 extracts the 2D feature point cloud data based on the pixel position of the 2D feature point cloud data estimated in step S24 or S25 (step S26).

Subsequently, the feature point cloud extraction unit 12 extracts 3D feature point cloud data corresponding to the 2D feature point cloud data extracted in step S26 (step S27). For example, the feature point cloud extraction unit 12 can extract coordinates of each piece of point data in the 3D feature point cloud data from the information on the pixel position of each piece of point data in the 2D feature point cloud data. Alternatively, the correspondence relationship between each piece of point data of the 2D feature point cloud data and each piece of point data of the 3D feature point cloud data may be stored in the predetermined storage apparatus (for example, the memory 18) or the like. In addition, at least one of point data of the 2D feature point cloud data and the point data of the 3D feature point cloud data may include information of the other corresponding point data.

Subsequently, the information processing apparatus 10d determines whether or not the extraction of the 3D feature point cloud data has been completed (step S28). In step S28, for example, the 2D image feature point cloud extraction unit 62 determines whether or not the 2D feature point cloud data can still be extracted from the first image data 70a. If the 2D feature point cloud data can be extracted, the 2D image feature point cloud extraction unit 62 extracts the 2D feature point cloud data in step S26.

If the extraction of the 3D feature point cloud data is completed, the three-dimensional model matching of the extracted 3D feature point cloud data is performed in step S3 in FIG. 6 or the like.

As illustrated in FIG. 14, in a case where there is the past frame, the information processing apparatus 10d can extract the 2D feature point cloud data with a low calculation amount based on the past frame. As a result, the calculation amount of the processing in step S2 in FIG. 6 can be reduced. Note that, in an initial state in which there is no past frame or other similar cases, the information processing apparatus 10d can acquire the 2D feature point cloud data from the user operation or the like.

Note that the 2D feature point cloud data may be extracted by image processing on the first image data 70a (for example, processing of extracting the feature point from luminance distribution), not limited to the method in steps S21 to S25.

As described above, the information processing apparatus 10d according to the second embodiment of the present disclosure acquires the 2D image data corresponding to the 3D point cloud data. In addition, the information processing apparatus 10d extracts the 2D feature point cloud data based on the luminance distribution of the 2D image data. The information processing apparatus 10d can extract the 3D feature point cloud data with high accuracy and a low calculation amount by extracting the 3D feature point cloud data corresponding to the 2D feature point cloud data from the 3D point cloud data.

The 2D feature point cloud data can also be extracted based on the 2D image data acquired in the past. That is, the misalignment amount of the pixel position can be detected through processing such as camera shake correction by comparing the 2D image data output by the ranging apparatus with the 2D image data output by the ranging apparatus in the past. The information processing apparatus 10d can extract the 2D feature point cloud data with a lower calculation amount based on the misalignment amount of the pixel position and the 2D feature point cloud data extracted from the past 2D image data.

In addition, the 2D feature point cloud data and the 3D feature point cloud data can be acquired manually or semi-manually by the user operation. For example, by indicating the cutout luminance range from the luminance distribution of the 2D image data, the object that can be matched with the three-dimensional model can be efficiently extracted from the 2D image data.

At least a part of the information processing apparatuses 10 and 10a to 10d described in the embodiments above (hereinafter, also simply referred to as the information processing apparatus 10) may be configured by hardware or software. In a case where the information processing apparatus 10 is configured by software, a program for implementing at least some functions of the information processing apparatus 10 may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

In addition, the program for implementing at least some functions of the information processing apparatus 10 may be distributed via a communication line (including wireless communication) such as the Internet. Further, the program may be distributed in an encrypted, modulated, or compressed state via a wired line or a wireless line such as the Internet or in a manner of being stored in a recording medium.

Note that the present technique can have the following configurations.

### [Item 1]

An information processing apparatus comprising:
a first extraction unit that extracts three-dimensional feature point cloud data from three-dimensional point cloud data in a first coordinate system;
a second extraction unit that extracts three or more specific points by matching the three-dimensional feature point cloud data with a three-dimensional model; and
an alignment unit that aligns the three or more specific points extracted by the second extraction unit in the first coordinate system with three or more specific points extracted in a second coordinate system.

### [Item 2]

The information processing apparatus according to item 1, wherein
the alignment unit performs relative alignment between the three-dimensional point cloud data in the first coordinate system and three-dimensional point cloud data in the second coordinate system based on the three or more specific points extracted by the second extraction unit in the first coordinate system and the three or more specific points in the second coordinate system.

### [Item 3]

The information processing apparatus according to item 1, wherein
three or more specific points extracted in another coordinate system are aligned with three or more specific points extracted in any one of a plurality of coordinate systems including the first coordinate system and the second coordinate system.

### [Item 4]

The information processing apparatus according to any one of items 1 to 3, wherein
the alignment unit estimates a transformation matrix from the first coordinate system to the second coordinate system based on the three or more specific points extracted by the second extraction unit in the first coordinate system and the three or more specific points in the second coordinate system.

### [Item 5]

The information processing apparatus according to any one of items 1 to 4, wherein
the first extraction unit extracts the three-dimensional feature point cloud data based on luminance information or design information of the three-dimensional point cloud data, or instruction information of a user.

### [Item 6]

The information processing apparatus according to any one of items 1 to 5, wherein
the second extraction unit sets three or more uniquely specified locations or vectors in a three-dimensional space as the three or more specific points.

### [Item 7]

The information processing apparatus according to item 6, wherein
the three-dimensional model includes at least one of a plane, a polyhedron, a sphere, a hemisphere, a prism, a cone, or a frustum existing in the three-dimensional space, and
the second extraction unit extracts the three or more specific points based on at least one of a specific coordinate position in the three-dimensional model, a normal vector at the specific coordinate position, or an axis vector of the three-dimensional model.

### [Item 8]

The information processing apparatus according to item 7, wherein
the three or more specific points include any one of a point on a normal line of the plane, a center of gravity of the polyhedron or the sphere, a center of the hemisphere, a vertex of the cone or a point obtained by adding an axis vector of the cone to the vertex, or a point obtained by adding an axis vector of the prism or the frustum to another specific point.

### [Item 9]

The information processing apparatus according to any one of items 1 to 8, further comprising
a third extraction unit that extracts a feature point included in the two-dimensional image data in the first coordinate system,
wherein the first extraction unit extracts the three-dimensional feature point cloud data including a point corresponding to the feature point extracted by the third extraction unit.

### [Item 10]

The information processing apparatus according to item 9, wherein
the two-dimensional image data is data in a same angle of view as the three-dimensional point cloud data.

### [Item 11]

The information processing apparatus according to item 9 or 10, wherein
the third extraction unit extracts the feature point based on luminance information of the two-dimensional image data.

### [Item 12]

The information processing apparatus according to any one of items 9 to 11, wherein
the third extraction unit extracts the feature point based on a misalignment of a plurality of pieces of the two-dimensional image data.

### [Item 13]

The information processing apparatus according to item 12, wherein
the third extraction unit detects the misalignment of the plurality of pieces of two-dimensional image data through camera shake correction processing.

### [Item 14]

The information processing apparatus according to any one of items 9 to 11, wherein
the third extraction unit extracts the feature point based on design information of the two-dimensional image data or instruction information of a user.

### [Item 15]

The information processing apparatus according to any one of items 1 to 14, wherein
the three-dimensional point cloud data is data generated based on a light reception signal or data designed by simulating the light reception signal, and
the light reception signal includes a light reception signal of reflection light from an object.

### [Item 16]

The information processing apparatus according to any one of items 9 to 14, wherein
the three-dimensional point cloud data is data generated based on a light reception signal or data designed by simulating the light reception signal,
the two-dimensional image data is data generated based on luminance information of the light reception signal or data designed by simulating the light reception signal, and
the light reception signal includes a light reception signal of reflection light from an object.

### [Item 17]

A ranging system comprising:
the information processing apparatus according to any one of items 1 to 16; and
a ranging apparatus that generates three-dimensional point cloud data in the first coordinate system and detects a distance of an object based on the three-dimensional point cloud data.

### [Item 18]

A ranging system comprising:
the information processing apparatus according to any one of items 9 to 14 and 16; and
a ranging apparatus that generates three-dimensional point cloud data and two-dimensional image in the first coordinate system and detects a distance of an object based on at least one of the three-dimensional point cloud data and the two-dimensional image.

### [Item 19]

An information processing method comprising:
extracting three-dimensional feature point cloud data from three-dimensional point cloud data in a first coordinate system;
extracting three or more specific points by matching the three-dimensional feature point cloud data with a three-dimensional model; and
aligning the three or more specific points extracted in the first coordinate system with three or more specific points extracted in a second coordinate system.

### [Item 20]

A program
causing an information processing apparatus to execute the steps of:
extracting three-dimensional feature point cloud data from three-dimensional point cloud data in a first coordinate system;
extracting three or more specific points by matching the three-dimensional feature point cloud data with a three-dimensional model; and
aligning the three or more specific points extracted in the first coordinate system with three or more specific points in a second coordinate system.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing apparatus comprising:
a first extraction unit that extracts three-dimensional feature point cloud data from three-dimensional point cloud data in a first coordinate system;
a second extraction unit that extracts three or more specific points by matching the three-dimensional feature point cloud data with a three-dimensional model; and
an alignment unit that aligns the three or more specific points extracted by the second extraction unit in the first coordinate system with three or more specific points extracted in a second coordinate system.

2. The information processing apparatus according to claim 1, wherein
the alignment unit performs relative alignment between the three-dimensional point cloud data in the first coordinate system and three-dimensional point cloud data in the second coordinate system based on the three or more specific points extracted by the second extraction unit in the first coordinate system and the three or more specific points in the second coordinate system.

3. The information processing apparatus according to claim 1, wherein
three or more specific points extracted in another coordinate system are aligned with three or more specific points extracted in any one of a plurality of coordinate systems including the first coordinate system and the second coordinate system.

4. The information processing apparatus according to claim 1, wherein
the alignment unit estimates a transformation matrix from the first coordinate system to the second coordinate system based on the three or more specific points extracted by the second extraction unit in the first coordinate system and the three or more specific points in the second coordinate system.

5. The information processing apparatus according to claim 1, wherein
the first extraction unit extracts the three-dimensional feature point cloud data based on luminance information or design information of the three-dimensional point cloud data, or instruction information of a user.

6. The information processing apparatus according to claim 1, wherein
the second extraction unit sets three or more uniquely specified locations or vectors in a three-dimensional space as the three or more specific points.

7. The information processing apparatus according to claim 6, wherein
the three-dimensional model includes at least one of a plane, a polyhedron, a sphere, a hemisphere, a prism, a cone, or a frustum existing in the three-dimensional space, and
the second extraction unit extracts the three or more specific points based on at least one of a specific coordinate position in the three-dimensional model, a normal vector at the specific coordinate position, or an axis vector of the three-dimensional model.

8. The information processing apparatus according to claim 7, wherein
the three or more specific points include any one of a point on a normal line of the plane, a center of gravity of the polyhedron or the sphere, a center of the hemisphere, a vertex of the cone or a point obtained by adding an axis vector of the cone to the vertex, or a point obtained by adding an axis vector of the prism or the frustum to another specific point.

9. The information processing apparatus according to claim 1, further comprising
a third extraction unit that extracts a feature point included in the two-dimensional image data in the first coordinate system,
wherein the first extraction unit extracts the three-dimensional feature point cloud data including a point corresponding to the feature point extracted by the third extraction unit.

10. The information processing apparatus according to claim 9, wherein
the two-dimensional image data is data in a same angle of view as the three-dimensional point cloud data.

11. The information processing apparatus according to claim 9, wherein
the third extraction unit extracts the feature point based on luminance information of the two-dimensional image data.

12. The information processing apparatus according to claim 9, wherein
the third extraction unit extracts the feature point based on a misalignment of a plurality of pieces of the two-dimensional image data.

13. The information processing apparatus according to claim 12, wherein
the third extraction unit detects the misalignment of the plurality of pieces of two-dimensional image data through camera shake correction processing.

14. The information processing apparatus according to claim 9, wherein
the third extraction unit extracts the feature point based on design information of the two-dimensional image data or instruction information of a user.

15. The information processing apparatus according to claim 1, wherein
the three-dimensional point cloud data is data generated based on a light reception signal or data designed by simulating the light reception signal, and
the light reception signal includes a light reception signal of reflection light from an object.

16. The information processing apparatus according to claim 9, wherein
the three-dimensional point cloud data is data generated based on a light reception signal or data designed by simulating the light reception signal,
the two-dimensional image data is data generated based on luminance information of the light reception signal or data designed by simulating the light reception signal, and
the light reception signal includes a light reception signal of reflection light from an object.

17. A ranging system comprising:
the information processing apparatus according to claim 1; and
a ranging apparatus that generates three-dimensional point cloud data in the first coordinate system and detects a distance of an object based on the three-dimensional point cloud data.

18. A ranging system comprising:
the information processing apparatus according to claim 9; and
a ranging apparatus that generates three-dimensional point cloud data and two-dimensional image in the first coordinate system and detects a distance of an object based on at least one of the three-dimensional point cloud data and the two-dimensional image.

19. An information processing method comprising: extracting three-dimensional feature point cloud data from three-dimensional point cloud data in a first coordinate system;
extracting three or more specific points by matching the three-dimensional feature point cloud data with a three-dimensional model; and
aligning the three or more specific points extracted in the first coordinate system with three or more specific points extracted in a second coordinate system.

20. A program executed by an information processing apparatus, the program comprising the steps of:
extracting three-dimensional feature point cloud data from three-dimensional point cloud data in a first coordinate system;
extracting three or more specific points by matching the three-dimensional feature point cloud data with a three-dimensional model; and
aligning the three or more specific points extracted in the first coordinate system with three or more specific points in a second coordinate system.
